(19) United States
(12) Patent Application Publication
(10) Pub. No.: US 2019/0104393 A1
(43) Pub. Date: Apr. 4, 2019

(54) Remote Triggering of Communication Through Computing Device

(71) Applicant: T-Mobile USA, Inc., Bellevue, WA (US)

(72) Inventors: Ruskin Taylor Lhamon, Bainbridge Island, WA (US); Mark Il An, Issaquah, WA (US)

(73) Assignee: T-Mobile USA, Inc.

(21) Appl. No.: 15/833,172

(22) Filed: Dec. 6, 2017

Related U.S. Application Data
(60) Provisional application No. 62/566,718, filed on Oct. 2, 2017.

(51) Int. Cl. H04W 4/90; G08B 25/01

(52) U.S. Cl. CPC H04W 4/90; G08B 25/016

(57) ABSTRACT

Remote triggering of a communication through a computing device is discussed herein. In the context of home security devices or a personal emergency response system (PERS) (e.g., a local device), a local device can provide an alert to a user equipment (e.g., a remote device). The remote device can respond to the alert by instructing the local device to initiate a communication between the local device, the remote device, and a network device (e.g., implemented as a public-safety answering point (PSAP)), wherein a location associated with the network device is based at least in part on a location of the local device. The alerts and communications can be directed or routed by a computing device (e.g., implemented as a communication server). A communication identifier can be associated with the local device and the remote device to allow for a communication to be reestablished in the event of an interruption.

### CROSS REFERENCE TO RELATED APPLICATIONS

This patent application claims priority filing benefit from U.S. Provisional Patent Application No. 62/566,718, filed Oct. 2, 2017, the entirety of which is hereby incorporated by reference.

### BACKGROUND

As the Internet-of-Things (“IoT”) industry begins to mature, a growing number of “connected” products may have wireless capabilities, but may not contain a screen, a dial pad, or even speakers or microphones. In the case of home security and personal safety, these devices can be used to monitor for “emergency” situations and to provide a notification if an emergency is detected. When detected, an emergency alert is often provided to a remote user (either a consumer or a professional monitoring service). Once the emergency is confirmed, the remote user often contacts a public-safety answering point (PSAP) to dispatch help. In some cases, since the user is remote, the remote user needs to dial a local access number to reach the appropriate PSAP. In other cases, a remote user initiating an emergency call may be incorrectly routed to a PSAP that is associated with a location of the remote user, which may not be the correct PSAP that services the area where the emergency is located. This frequently results in lower priority dispatch, or no service, in some cases.

In some cases, if a local personal safety device is configured to automatically emit a signal or make a call for emergency assistance, it is possible that the call may be routed to the proper PSAP due to the location of the personal safety device placing the call. However, if the person associated with the personal safety device and/or the emergency is incapacitated, the PSAP personnel will not be able to properly assess the situation and may not dispatch the appropriate assistance.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example environment including a first computing device (e.g., implemented as a home security device), a second computing device (e.g., implemented as a communication server), a user equipment, and a network device (e.g., implemented as a public-safety answering point), as described herein.

FIG. 2 illustrates an example environment including a first computing device (e.g., implemented as a personal emergency response system), a second computing device (e.g., implemented as a communication server), a user equipment, and a network device (e.g., implemented as a public-safety answering point), as described herein.

FIG. 3 illustrates an example computing device configured to implement the remote triggering of a communication through the computing device, in accordance with embodiments of the disclosure.

FIG. 4 illustrates an example user equipment configured to implement the remote triggering of a communication through a computing device, in accordance with embodiments of the disclosure.

FIG. 5 illustrates an example process for remotely triggering a communication through a local computing device, as described herein.

FIG. 6 illustrates an example process for reestablishing a communication, as described herein.

FIG. 7 illustrates an example process for receiving an invitation to receive a communication and associating communication identifier based on accepting the invitation, as described herein.

### DETAILED DESCRIPTION

Systems, devices, and methods are directed to remote triggering of a communication through a computing device. For example, in the context of home security devices or systems, or a personal emergency response system (PERS) (e.g., a local device), such a local device can provide an indication of an event or an alert to a user equipment (e.g., a remote device). The remote device can respond to the indication or alert by instructing the local device to initiate a communication between the remote device, a network device (e.g., implemented as a public-safety answering point (PSAP)), and/or the local device, wherein the relevant network device is based at least in part on a location of the local device. That is, a location associated with the network device can be based at least in part on a location of the local device. The instructions, indications, alerts, communications, and the like can be directed or routed by a computing device (e.g., implemented as a communication server).

In some instances, the remote device can be a mobile device such that a location of the remote device may not be fixed. Further, the remote device can be physically separate from the local device (e.g., in another city, state, country, and the like). In any event, it may be the case that a location of the remote device is different from the location of the local device. In some instances, the systems, devices, and methods discussed herein avoid a situation where a communication is initiated by the remote device, such that the remote device is communicatively connected to a network device that is not associated with a location of the local device. Further, the systems, devices, and methods avoid a situation whereby a remote device directly initiates a communication with a network device associated with a location of the local device, and whereby such a direct communication receives a low-priority status by the network device.

In some instances, the systems, devices, and methods facilitate a recovery or reconnection procedure when a communication is disrupted between the local device (e.g., a home security device or system, or a PERS), a remote device (e.g., a user equipment), and a network device (e.g., a PSAP). For example, prior to an event or emergency (such as during device registration or installation an application), the local device can transmit an invitation to the remote device to accept indications of events and/or alerts from the local device. In some instances, upon accepting the invitation, the local device can associate a communication identifier or a native number of the local device with the remote device. In some instances, the remote device can associate a communication identifier or native number of the remote device with the communication identifier or native number associated with the local device. In some instances, a user profile associated with the local device can be updated to refer to associations between native number(s) and/or communication identifier(s) of local devices and/or remote devices independent of any invitation or acceptance, as discussed herein.

Thus, following this initial registration or association step, or following an association between native number(s) and/or communication identifier(s) (e.g., at any time), and in the event that a communication is disrupted, when the network device (e.g., the PSAP) attempts to reestablish the communication with the local device, the remote device and/or the local device can substantially simultaneously receive invitations to initiate a communication session. In some instances, such invitation to initiate a communication session can include, but are not limited to, dialing of one or more of a native number or communication identifier, initiating a voice-over internet protocol (VOIP) session request, etc. That is, based at least in part on associating a communication identifier between the remote device and local device, when a network device calls back the local device in response to a communication disruption, the local device and/or the remote device can accept the call to reestablish the communication. Thus, a communication can be reestablished between the network device, the remote device, and/or the local device in the event of a communication disruption.

In some instances, a computing device implemented as a communication server can receive data and transmit data to and from the various devices including a computing device (e.g., implemented as a home security device or system, or implemented as a PERS), the computing device implemented as the communication server, a user equipment, and a network device (e.g., implemented as a public-safety answering point),

The systems, devices, and techniques described herein can improve a functioning of a network by implementing functionality such that a location associated with a network device (e.g., a PSAP that provides services to a particular location) can be based at least in part on a local device that is proximate to an event or emergency. The operations discussed herein can more accurately route calls, thereby reducing overall network congestion. Further, the systems, devices, and techniques can improve a user experience by improving safety outcomes in emergency situations. In some instances, reducing instances of incorrectly routed calls can allow first-responders to arrive at a scene of an emergency faster, which may result in more positive outcomes.

In some instances, the systems, devices, and techniques described herein can further reduce network congestion and/or congestion at a PSAP by reducing occurrences of false positive alerts. For example, the architecture discussed herein allows a local device to provide an indication or an alert to a remote device, whereby the remote device can ultimately determine whether to initiate a communication with a PSAP. By confirming the presence of an event or emergency, instances where a communication is incorrectly initiated can be reduced or eliminated, thereby reducing network congestion and/or reducing a burden on PSAP resources. Further, the architecture is backwards compatible with various implementations of PSAPs, thereby improving a reliability of emergency responses. These and other improvements to the functioning of a computer and network are discussed herein.

The systems, devices, and techniques described herein can be implemented in a number of ways. Example implementations are provided below with reference to the following figures.

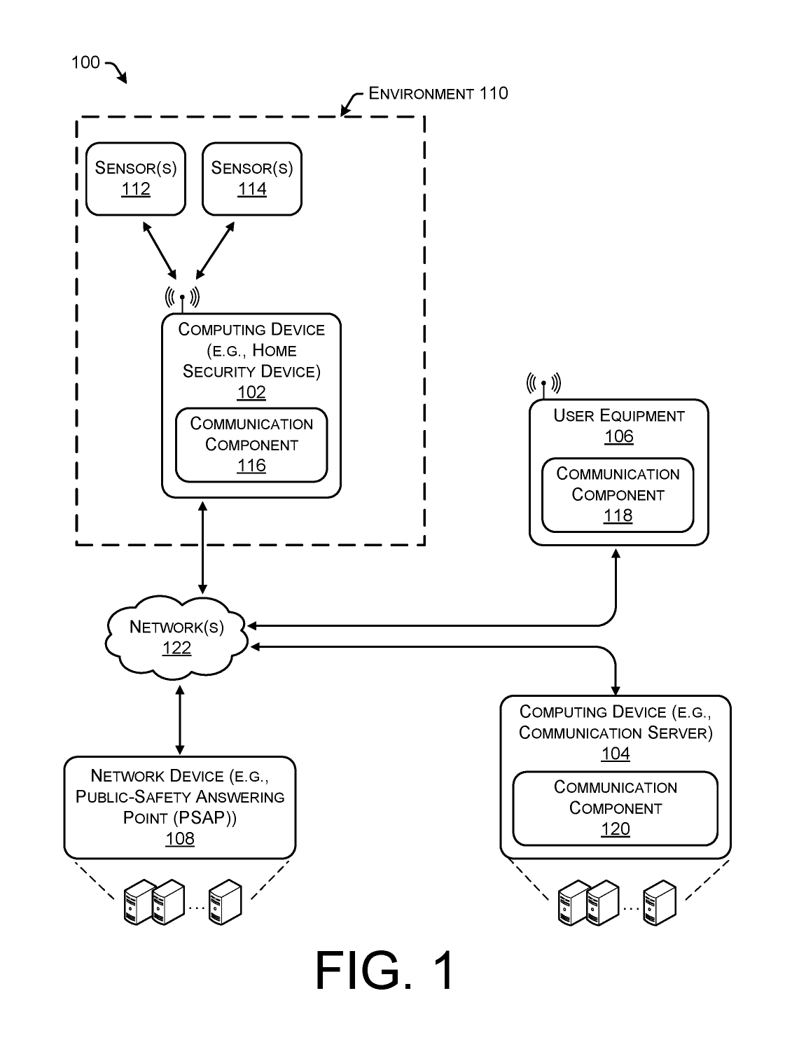

FIG. 1 illustrates an example environment 100 including a first computing device 102 (e.g., implemented as a home security device), a second computing device 104 (e.g., implemented as a communication server), a user equipment 106, and a network device 108 (e.g., implemented as a public-safety answering point), as described herein.

In some instances, the computing device 102 can be located in an environment 110, such as a home or office of a user. In some instances, the computing device 102 can be a home security device that receives sensor data from one or more sensors 112 and 114. In some instances, the sensors 112 and 114 can represent one or more image sensor(s), door sensor(s), lock sensor(s), window sensor(s), audio sensor(s), water sensor(s), humidity sensor(s), temperature sensor(s), motion sensor(s), smoke detector(s), carbon monoxide sensor(s), panic alarm(s), electrical panel status detector(s), panic button(s), and the like. Of course, the environment can include any number of similar computing device 102 and/or sensors.

The computing device 102 can receive information from the sensors 112 and 114 and can determine a presence of an alert or event (e.g., a security alert, a safety alert, or other indication). In some instances, the computing device 102 can determine the alert locally (e.g., at the computing device 102), and in some instances, the computing device 102 can transmit sensor data to a remote device for processing. In some instances, a remote device may have more processing capability and/or can store a profile (e.g., including facial recognition profiles, voice recognition profiles, and the like) to be utilized in determining the alert. Upon determining the presence of an alert, or upon determining a confidence level associated with the alert being above one or more threshold values, the computing device 102 can transmit an indication of an event, an alert, or data to the user equipment 106. In some instances, the alert can correspond to device states (e.g., open doors, presence of water, temperature above a threshold, motion detected in image data, etc.), and are not limited to security or safety alerts.

The computing device 102 can include a communication component 116 for sending and/or receiving data to and/or from a communication component 118 associated with the user equipment 106, a communication component 120 associated with the computing device 104, and/or the network device 108. In some instances, the computing device 102, the computing device 104, the user equipment 106, and the network device 108 can communicate via the one or more networks 122.

As mentioned above, upon determining the presence of an event or an emergency associated with the environment 110, for example, the communication component 116 associated with the computing device 102 can provide an alert or an indication of an event to the communication component 118 of the user equipment 106.

The user equipment 106 can receive the alert and present the alert to a user via the communication component 118 (or other components of the user equipment 106, as discussed herein). The communication component 118 is configured to receive, for example, via a user interface, a request to initiate a communication based on the alert or indication, such as an emergency call. In such a case, the communication component 118 can provide an indication, data, and/or a request to the communication component 116 to initiate the communication, such as an emergency call.

In response, the communication component 116 can initiate a communication or call with the communication component 118. Upon confirming the connection (e.g., upon initiation of a communication between the computing device 102 and the user equipment 106), the communication component 116 can initiate a conference call with the user equipment 106, the computing device 102, and the network device (e.g., implemented as a public-safety answering point (PSAP)) 108. In some instances, in response to receiving a request to initiate a communication based on the alert or indication, the communication component can initiate a call between the user equipment 106 and the network device 108 without participating in the call. That is, the communication is not required to include the computing device 102 in all implementations. Because the computing device 102 initiates the communication or call (e.g., to an emergency provider such as 911), the network device (e.g., implemented as a PSAP) 108 receives location information (and any additional information the network device 108 and/or the computing device 102 are able to share) associated with the computing device 102 (and accordingly, associated with the alert).

In some instances, an order of establishing communication between the computing device 102, the user equipment 106, and/or the network device 108 can vary based on a specific implementation. For example, in some instances (based at least in part on receiving a request to initiate the communication from the user equipment 106), the computing device 102 can initiate a first communication between the computing device 102 and the network device 108, can initiate a second communication between the computing device 102 and the user equipment 106, and can join the first communication and the second communication into a third communication (e.g., a conference call). Other variations of establishing communications are contemplated herein.

In some instances, the computing device 102 can provide audio data, image data, and/or other data to the user equipment 106 and/or the network device 108 before, during, and/or after the conference call, as discussed herein. For example, such other data may include, but is not limited to, weather data, traffic data, social media data, event data (e.g., occupancy data) and the like.

Examples of the computing device 102 can include, but are not limited to, security devices, systems, or hubs, smart phones, mobile phones, cell phones, tablet computers, portable computers, laptop computers, personal digital assistants (PDAs), electronic book devices, wearable devices, or any other portable electronic devices that can generate, request, receive, transmit, or exchange voice, video, and/or digital data over a network. Additional examples of the computing device 102 include, but are not limited to, smart devices such as televisions, refrigerators, washing machines, dryers, smart mirrors, coffee machines, lights, lamps, temperature sensors, music players, headphones, or any other electronic appliances that can generate, request, receive, transmit, or exchange voice, video, and/or digital data over a network.

In some instances, the computing device 104 implemented as a communication server can facilitate communications by and between the various devices in the environment 100. That is, the communication component 120 and/or the computing device 104 can represent any computing devices implementing various aspects of one or more of second, third, fourth, and fifth generation (2G, 3G, 4G, and 5G) cellular-wireless access technologies, which may be cross-compatible and may operate collectively to provide data communication services. Global Systems for Mobile (GSM) is an example of 2G telecommunications technologies; Universal Mobile Telecommunications System (UMTS) is an example of 3G telecommunications technologies; and Long Term Evolution (LTE), including LTE Advanced, and Evolved High-Speed Packet Access (HSPA+) are examples of 4G telecommunications technologies. Thus, the computing device 104 may implement GSM, UMTS, LTE/LTE Advanced, Wi-Fi, WiMAX, satellite communications, Bluetooth, Bluetooth Low Energy, Zigbee, LoRa, or other telecommunications technologies. The computing device 104 may include, but is not limited to, a combination of: base transceiver stations BTSs (e.g., NodeBs, Enhanced-NodeBs), Radio Network Controllers (RNCs), serving GPRS support nodes (SGSNs), gateway GPRS support nodes (GGSNs), proxies, a mobile switching center (MSC), a mobility management entity (MME), a serving gateway (SGW), a packet data network (PDN) gateway (PGW), an evolved packet data gateway (e-PDG), an Internet Protocol (IP) Multimedia Subsystem (IMS), or any other data traffic control entity configured to communicate and/or route data packets between the computing device 102, the user equipment 106, the network device 108, and/or the network(s) 122. In some embodiments, the computing device 104 is operated by a service provider. While FIG. 1 illustrates a computing device 104, it is understood in the context of this document, that the techniques discussed herein may also be implemented in other networking technologies, such as nodes that are part of a wide area network (WAN), metropolitan area network (MAN), local area network (LAN), neighborhood area network (NAN), personal area network (PAN), or the like.

Examples of the network 122 can include, but are not limited to networks including second-generation (2G), third-generation (3G), fourth-generation (4G) cellular networks, or fifth generation (5G) cellular networks, such as LTE (Long Term Evolution) via VoLTE (Voice Over LTE) using SIP (Session Initiation Protocol) signaling, and data networks, such as Wi-Fi networks carrying VoIP (Voice Over Internet Protocol) calls.

Another example of signaling and communication flow is provided below. For example, and without limitation, when a “call 911” button is pushed or otherwise selected or activated (e.g., in connection with the communication component 118), the operations can include: 1) sending, from the communication component 118 to the communication component 116 (e.g., via the communication component 120), an electronic command to place a 911 emergency call; 2) the computing device 102 can place a (non-emergency) call to the communication component 118 (e.g., a remote user) utilizing the communication component 116; 3) the remote user can answer the phone or device (e.g., the user equipment 106); the computing device 102 can initiate a second call (e.g., as an enhanced 911 (e911) call) to 911 (e.g., the network device 108 representing a PSAP); 5) the network device 108 can receive the local e911 call from the computing device 102 (which correctly locates the emergency) and a PSAP operator is able to speak directly to the remote user associated with the user equipment 106; 6) the remote user (e.g., of the user equipment 106) can identify the emergency and use an application (e.g., the communication component 118) to provide additional data, such as video clips, live video monitoring, audio data, etc. to the network device 108; and 7) when possible, the computing device 102 can be enabled to provide a bridge to a local audio data, image data, or other data (e.g., when the computing device 102 and/or sensors 112 and/or 114 include microphone(s), image sensor(s), or any other various sensors (e.g., LIDAR, RADAR, SONAR, temperature sensor, pressure sensor, magnetometer, and the like)).

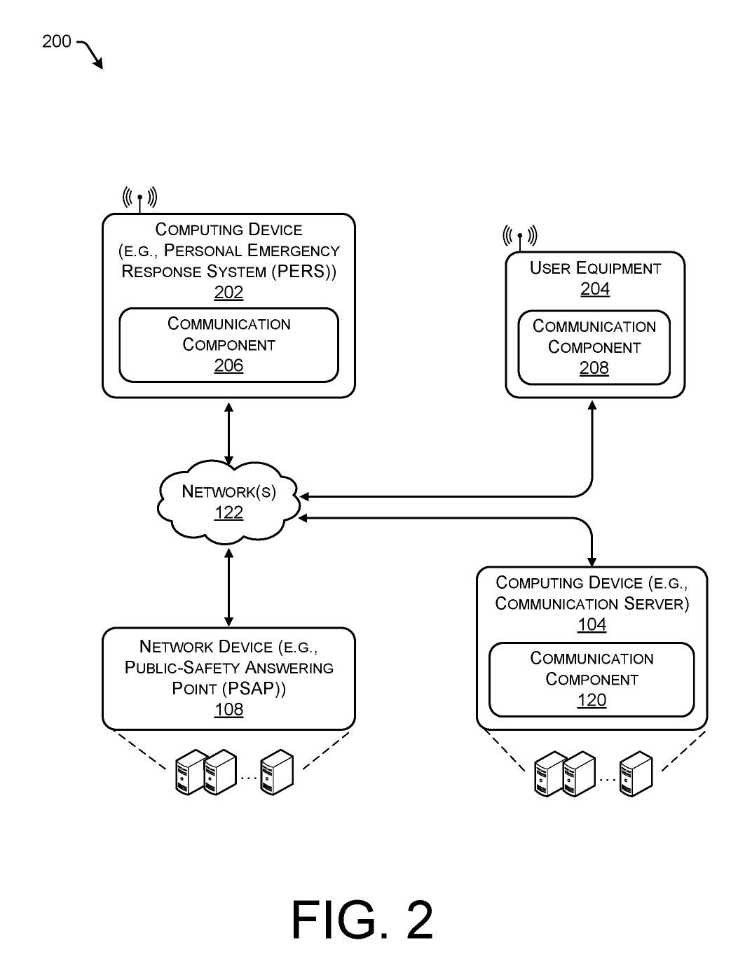

FIG. 2 illustrates an example environment 200 including a first computing device 202 (e.g., implemented as a personal emergency response system), the second computing device 104 (e.g., implemented as a communication server), a user equipment 204, and a network device 108 (e.g., implemented as a public-safety answering point), as described herein.

In some instances, the computing device 202 can be implemented as a smart watch, a wearable device, or a portable device. In one use case, the computing device 202 can include a communication component 206 that can send an indication of an event or an alert to a communication component 208 associated with the user equipment 204. In some instances, the communication component 206 can perform similar functions as discussed in connection with the communication component 116. Further, in some instances, the communication component 208 can perform similar functions as discussed in connection with the communication component 118. Accordingly, the computing device 202 can provide an indication of an event and/or an alert to the user equipment 204 (e.g., directly or via the computing device 104), and can initiate a conference call (or any communication type) between the computing device 202, the user equipment 204, and the network device 108, wherein the location associated with the network device 108 can be based on a location of the computing device 202.

In some instances, the computing devices 102, 104, 202, the user equipment 106 and 204, and the network device 108 can communicate via any protocols including but not limited to: 2G, 3G, 4G, 4G LTE, 5G, Wi-Fi, RF (radio frequency), cellular, satellite, Bluetooth, wired, and the like.

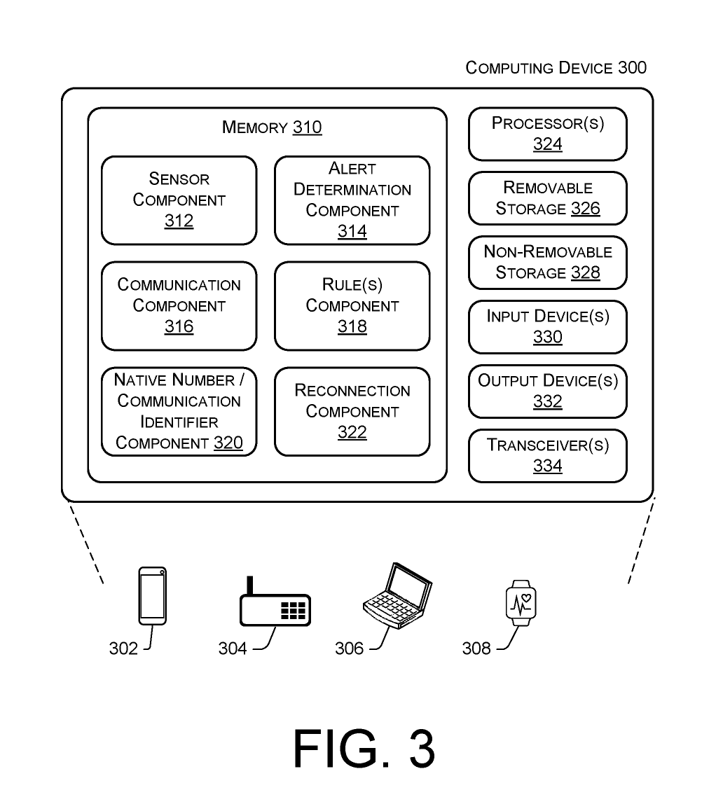

FIG. 3 illustrates an example computing device 300 configured to implement the remote triggering of a communication through the computing device, in accordance with embodiments of the disclosure. In some embodiments, the computing device 300 can correspond to the computing devices 102, 104, and 202 of FIGS. 1 and 2. It is to be understood in the context of this disclosure that the computing device 300 can be implemented as a single device or as a plurality of devices with components and data distributed among them. By way of example, and without limitation, the computing device 300 can be implemented as a smartphone 302, a home security device or system 304, a laptop 306 (representing one or more computers or server computers), and a wearable device 308 (e.g., a smartwatch, fob, or a personal emergency response system (PERS)).

As illustrated, the computing device 300 comprises a memory 310 storing a sensor component 312, an alert determination component 314, a communication component 316, a rule(s) component 318, a native number/communication identifier component 320, and a reconnection component 322. Also, the computing device 300 includes processor(s) 324, a removable storage 326 and non-removable storage 328, input device(s) 330, output device(s) 332, and transceiver(s) 334.

In various embodiments, memory 310 is volatile (such as RAM), non-volatile (such as ROM, flash memory, etc.) or some combination of the two. The sensor component 312, the alert determination component 314, the communication component 316, the rule(s) component 318, the native number/communication identifier component 320, and the reconnection component 322 stored in the memory 310 can comprise methods, threads, processes, applications or any other sort of executable instructions. The sensor component 312, the alert determination component 314, the communication component 316, the rule(s) component 318, the native number/communication identifier component 320, and the reconnection component 322 can also include files and databases.

The sensor component 312 can include functionality to receive sensor data from one or more sensors. For example, when implemented as a home security device in an environment, the sensor component 312 can receive data via wired or wireless communications. In some instances, sensor data to be received by the sensor component 312 can include, but is not limited to: image data, audio data, door indications (e.g., identity of a door, data indicating a state of the door (e.g., open or closed)), window indications (e.g., identity of a window, data indicating a state of the window (e.g., open or closed)), temperature data, pressure data, humidity data, pH (e.g., of a liquid), accelerometer data, GPS data, LIDAR data, RADAR data, SONAR data, and the like. As may be appreciated, the number of sensors and the type of sensor data received by the sensor component 312 is virtually limitless. In some instances, the sensor component 312 can utilize any communication protocols, including but not limited to one or more of: Wi-Fi, cellular, Bluetooth, Bluetooth Low Energy, Zigbee, LoRa, and the like.

The alert determination component 314 can include functionality to receive sensor data received by the sensor component 312 and analyze the sensor data to determine the presence of an event or an emergency. In some instances, based at least in part on the determination of the presence of an event or an emergency, the alert determination component 314 can cause one or more alerts to be sent to user equipment, network devices, and/or computing devices, as discussed herein. In some instances, the alert determination component 314 can send sensor data to a remote computing device so that processing can be performed on the sensor data to determine the event or emergency. By way of example, the alert determination component 314 can receive sensor data indicating that a door sensor has been triggered, and that an alarm associated with an environment is active. Further, the alert determination component 314 can determine that the alarm has not been disabled within a threshold amount of time. In some instances, the alert determination component 314 can include various rules (or can operate in conjunction with the rule(s) component 318) that, when satisfied, can indicate the presence of an event or an emergency.

The communication component 316 can include functionality to send one or more indications of an event or alerts in response to determinations of the event or emergency, as discussed herein. In some instances, the communication component 316 can send and receive data and other indications with the various communication components discussed herein. In some instances, the communication component 316 can include any encryption and/or compression to preserve a security of the components discussed herein, and to reduce an amount of data to be sent.

Further, the communication component 316 can include functionality to access contacts stored in computing device 300 (or in a remote computing device such as the computing device 104). For example, the communication component 316 can store names, addresses, numbers (e.g., native numbers, communication identifiers, etc.) associated with various contacts. In some instances, the communication component 316 can add, edit, and/or delete contacts on the computing device 300, which can be synchronized with a contact list or user profile stored remotely, such as on the computing device 104.

In some instances, the communication component 316 can include functionality to determine a first location of the computing device 300 and to determine a second location of a device in communication with the communication component (e.g., the user equipment 106). Further, the communication component 316 can compare the first location to the second location to determine whether a first call that was initiated by the user equipment would result in a same network device (e.g., a PSAP) as a second call (e.g., a same call as the first call) that was initiated by the computing device 300. In some instances, if the first call and the second call would result in the same network device (e.g., a same PSAP), the communication component 316 can select either the computing device or the user equipment to initiate a communication with a network device (e.g., a PSAP).

In some instances, the communication component 316 can include functionality to extrapolate a location of the computing device 300 to determine a location where the computing device 300 may be in the future to allow for a responder to provide services to a user or location associated with the computing device 300. For example, in a case where the computing device 300 is implemented in a train or car (or in a wearable device carried by a person on a train or car), the communication component 316 can include functionality to determine a current location of the computing device 300 and to determine a location where the computing device 300 may be at a subsequent time. For example, an emergency on a train may occur in a first jurisdiction or region associated with a first PSAP, but based on a current state of the computing device (e.g., speed, velocity, etc.), the communication component 316 can determine that a second PSAP associated with a second location may be contacted to provide a more timely response.

The rule(s) component 318 can include functionality to implement a rules-based approach to determining a presence of an event or emergency, transmitting one or more indications or alerts, and initiating communications between devices, as discussed herein. In some instances, the rule(s) component 318 can present a user interface or otherwise allow one or more users to define rules or parameters indicating actions to be taken in response to preconditions. For example, the rule(s) component 318 can include rules regarding a confidence value or level associated with determining an event or emergency. The rule(s) component 318 can include rules regarding which user equipment to contact in which order and/or in response to various events or emergencies. The rule(s) component 318 can include rules regarding data types to be sent in connection with and alert (e.g., audio data, image data, and the like).

The native number/communication identifier component 320 can include functionality to access, assign, and/or associate various native number(s) and/or communication identifier(s) with various devices, as discussed herein. In some embodiments, a native number corresponds to an E.164 address or identity assigned (such as an IMSI) to the computing device. For example, the native number can correspond to a phone number such as “555-111-2222”. In some embodiments, the native number/communication identifier component 320 can include an application that enables calls to be originated via Voice over Internet Protocol (VoIP), circuit switched voice, or some other protocol, using Session Initiation Protocol (SIP) signaling. In some embodiments, the communication identifiers can include phone numbers or other identifiers allocated by a computing device (e.g., the computing device 104) for use in connection with the native number(s). However, in some embodiments, the communication identifier is not associated with any computing devices (e.g., via a Subscriber Identity Module, SIM card, or via a Removable User Identity Module, etc.) or user equipment until a particular communication identifier is activated for use at the computing device or user equipment. Thus, a user can activate a communication identifier at a computing device or at a user equipment, for example, and native number/communication identifier component 320 can be used to initiate calls and transfer calls to and from the various communication identifiers. Further, the native number/communication identifier component 320 or another application or interface provided by the computing device 300 can permit a user to select, enter, or view the communication identifiers, or to add descriptions for the communication identifiers, such as “cell phone,” “neighbor,” “work,” “security company,” etc.

That is, the native number/communication identifier component 320 allows the computing device 300 to utilize a native number and/or a communication identifier to communicate with devices via the network 122. In some instances, the native number/communication identifier component 320 can be utilized to associate a communication identifier with any number of computing devices and/or user equipment.

In some instances, a communication identifier can be activated at the computing device 300 such that whenever the computing device 300 alerts a user equipment (e.g., the user equipment 106, 204) and when the user equipment initiates a call or communication in response to the alert, the communication identifier activated by the computing device 300 can be enabled for user equipment. Further, upon a resolution of the alert (e.g., canceling the alert, passage of a predetermined amount of time, etc.), the communication identifier can be disabled at the user equipment. In some instances, the native number/communication identifier component 320 can send one or more instructions to the various devices discussed herein to enable or disable a communication identifier, as discussed herein.

The reconnection component 322 can include functionality to reestablish a connection by and between the computing device 300 and one or more network devices, user equipment, and/or other computing devices. Further, the reconnection component 322 can determine when a communication has ended, and/or can store a log or database identifying which network devices, user equipment, and/or other computing devices have been part of a communication. In some instances, the reconnection component 322 can determine that a communication has ended, can receive a request (from the network device and/or from the user equipment) to reestablish the communication, can reestablish a communication between the requesting device (e.g., the network device or the user equipment), and can transmit a request to the other respective party to the ended communication (e.g., the network device or the user equipment).

In some instances, the reconnection component 322 can include functionality to add additional user equipments to a communication with a network device (e.g., a PSAP) and for these additional user equipments to be included in a reestablished communication. For example, in some instances, a PSAP operator may request additional information that a user associated with a first user equipment cannot provide but that a user associated with a second user equipment may be able to provide. Thus, the reconnection component 322 can receive additional native numbers and/or connection identifiers to ensure that communication is reestablished with the appropriate devices.

By way of example and without limitation, in a communication between the computing device 300, a network device, and a user equipment, upon the communication ending, the reconnection component 322 can receive a request to reestablish the communication from the network device. In some instances, the network device may not have the address (e.g., native number) of the user equipment, and so the network cannot unilaterally reestablish the communication between the network device, the computing device 300, and the user equipment. Accordingly, the reconnection component 322 can accept the request to establish a communication between the computing device 300 and the network device, and can initiate a communication with the user equipment (as a conference call, or as a two-party communication followed by joining the calls, and the like).

In some embodiments, the processor(s) 324 is a central processing unit (CPU), a graphics processing unit (GPU), or both CPU and GPU, or other processing unit or component known in the art.

The computing device 300 also includes additional data storage devices (removable and/or non-removable) such as, for example, magnetic disks, optical disks, tape, flash drives, and the like. Such additional storage is illustrated in FIG. 3 by removable storage 326 and non-removable storage 328. Tangible computer-readable media can include volatile and nonvolatile, removable and non-removable media implemented in any method or technology for storage of information, such as computer readable instructions, data structures, program modules, or other data. Memory 310, removable storage 326 and non-removable storage 328 are all examples of computer-readable storage media. Computer-readable storage media include, but are not limited to, RAM, ROM, EEPROM, flash memory or other memory technology, CD-ROM, digital versatile discs (DVD), content-addressable memory (CAM), or other optical storage, magnetic cassettes, magnetic tape, magnetic disk storage or other magnetic storage devices, or any other medium which can be used to store the desired information and which can be accessed by the computing device 300. Any such tangible computer-readable media can be part of the computing device 300.

The computing device 300 also can include input device(s) 330, such as a keypad, a cursor control, a touch-sensitive display, voice input device, etc., and output device(s) 332 such as a display, speakers, printers, etc. These devices are well known in the art and need not be discussed at length here.

As illustrated in FIG. 3, the computing device 300 also includes one or more wired or wireless transceiver(s) 334. For example, the transceiver(s) 334 can include a network interface card (NIC), a network adapter, a LAN adapter, or a physical, virtual, or logical address to connect to various network(s) 122, or to the computing device 104, for example. To increase throughput when exchanging wireless data, the transceivers 334 can utilize multiple-input/multiple-output (MIMO) technology. The transceiver(s) 334 can comprise any sort of wireless transceivers capable of engaging in wireless, radio frequency (RF) communication. The transceivers 334 can also include other wireless modems, such as a modem for engaging in Wi-Fi, WiMax, Bluetooth, Bluetooth Low Energy, ZigBee, Z-Wave, LoRa, Thread, mesh, infrared communication, or the like.

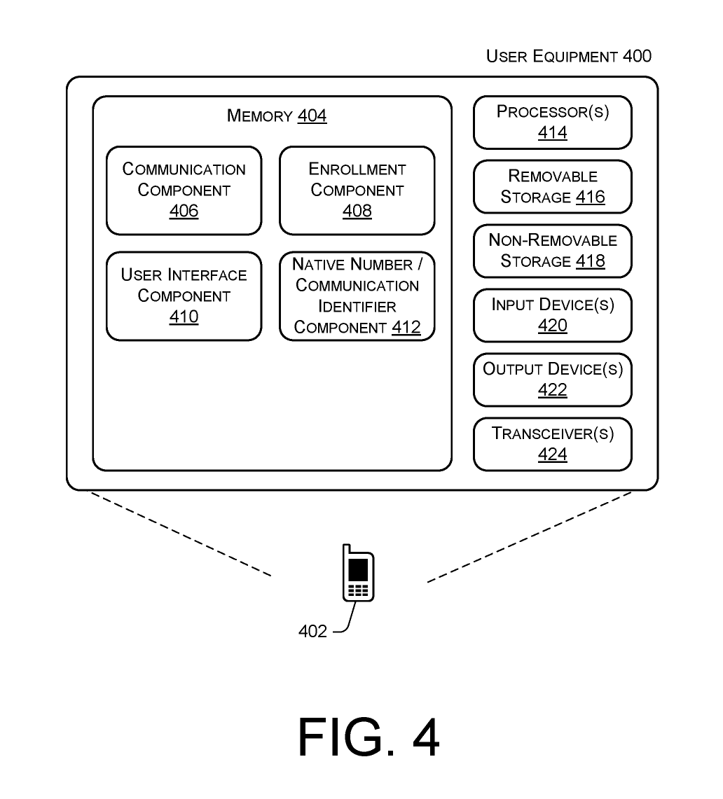

FIG. 4 illustrates an example user equipment 400 configured to implement the remote triggering of a communication through a computing device, in accordance with embodiments of the disclosure. In some embodiments, the user equipment 400 can correspond to the user equipment 106 or 204 of FIGS. 1 and 2, respectively. It is to be understood in the context of this disclosure that the user equipment 400 can be implemented as a single device or as a plurality of devices with components and data distributed among them. By way of example, and without limitation, the user equipment 400 can be implemented as one or more smart phones 402, mobile phones, cell phones, tablet computers, portable computers, laptop computers, personal digital assistants (PDAs), electronic book devices, handheld gaming units, personal media player devices, wearable devices, or any other portable electronic devices that may generate voice and/or digital data, request voice and/or digital data over the network 122, receive voice and/or digital data over the network 122, and/or exchange voice, digital data, and/or analog data over the network 122.

As illustrated, the user equipment 400 comprises a memory 404 storing a communication component 406, an enrollment component 408, a user interface component 410, and a native number/communication identifier component 412. Also, the user equipment 400 includes processor(s) 414, a removable storage 416 and non-removable storage 418, input device(s) 420, output device(s) 422, and transceiver(s) 424.

In various embodiments, the memory 404 is volatile (such as RAM), non-volatile (such as ROM, flash memory, etc.) or some combination of the two. The communication component 406, the enrollment component 408, the user interface component 410, and the native number/communication identifier component 412 stored in the memory 404 can comprise methods, threads, processes, applications or any other sort of executable instructions. The communication component 406, the enrollment component 408, the user interface component 410, and the native number/communication identifier component 412 can also include files and databases.

The communication component 406 can include functionality to receive one or more indications of an event or alerts (e.g., from computing device(s) implemented as a home security device or a PERS), as discussed herein. In some instances, the communication component 406 can send and receive data and other indications with the various communication components discussed herein. In some instances, the communication component 406 can include any encryption and/or compression to preserve a security of the components discussed herein, and to reduce an amount of data to be sent.

The enrollment component 408 can include functionality to receive an invitation or enrollment request from a computing device, for example, to configure the user equipment 400 to receive the indications and/or alerts, as discussed herein. For example, as an initial setup or registration process of the computing device, the computing device can send an invitation to the user equipment 400. In some instances, the invitation can include information associated with the computing device, such as an address (physical and/or electronic), a number/type of sensors, types of data gathered, frequency of updates, and the like. The enrollment component 408 can present the specifications of the computing device and/or environment to the user equipment 400. A user can accept the invitation, and based at least in part on the acceptance, the enrollment component 408 can send data associated with the acceptance to a computing device (e.g., the computing device 102, 202, or 104). In some instances, the computing device and the user equipment can be associated (e.g., in a user profile, in a registration table, etc.) based at least in part on the acceptance.

The user interface component 410 can include functionality to receive audio data and/or image data from a corresponding computing device (e.g., the computing device 102 or 202) and can present the data via the user equipment 400. For example, the user interface component 410 can receive image data that has been captured by an image sensor, sent to a computing device (e.g., the computing device 102 or 202) and analyzed to determine a confidence value associated with a presence of an event or emergency. In some instances, the image data can be sent to the user equipment 400 and presented via the user interface component 410. In some instances, the user interface component 410 can receive instructions to confirm or deny the presence of the event or the emergency. For example, and without limitation, a user can view the image data to determine that an unknown person in in their house, and can initiate the communication processes, and discussed herein.

In some instances, the user interface component 410 can include functionality to select sensors and/or present sensor data associated with a particular sensor. For example, in an environment including multiple image sensors, the user interface component 410 can include functionality to select a particular image sensor to display image data associated with the image sensor. In some instances, based at least in part on a capability of a sensor, the user interface component 410 can provide an interface to allow for sensors to be manipulated, such as changing an orientation (e.g., pan, tilt, rotate, etc.), zooming (e.g., in/out), and the like.

The native number/communication identifier component 412 can include functionality to associate the user equipment 400 with one or more communication identifiers associated with the computing device, as discussed herein. For example, the native number/communication identifier component 412 can store a user profile associated with a first user or user equipment (e.g., the user equipment 400). As communication identifiers are associated or disassociated with various computing devices or with various profiles, the native number/communication identifier component 412 can be updated to reflect the mapping between communication identifier(s), native number(s), computing device(s), user equipment, and the like.

In some instances, the native number/communication identifier component 412 can include some or all of the aspects of the reconnection component 322, such that the user equipment 400 can add additional numbers or identifier to be contacted in the event a connection is interrupted.

In some embodiments, the processor(s) 414 is a central processing unit (CPU), a graphics processing unit (GPU), or both CPU and GPU, or other processing unit or component known in the art.

The user equipment 400 also includes additional data storage devices (removable and/or non-removable) such as, for example, magnetic disks, optical disks, or tape. Such additional storage is illustrated in FIG. 4 by removable storage 416 and non-removable storage 418. Tangible computer-readable media can include volatile and nonvolatile, removable and non-removable media implemented in any method or technology for storage of information, such as computer readable instructions, data structures, program modules, or other data. Memory 404, removable storage 416 and non-removable storage 418 are all examples of computer-readable storage media. Computer-readable storage media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by the user equipment 400. Any such tangible computer-readable media can be part of the user equipment 400.

The user equipment 400 can include input device(s) 420, such as a keypad, a cursor control, a touch-sensitive display, etc. Also, the user equipment 400 can include output device(s) 422, such as a display, speakers, etc. These devices are well known in the art and need not be discussed at length here.

As illustrated in FIG. 4, the user equipment 400 can include one or more wired or wireless transceiver(s) 424. In some wireless embodiments, to increase throughput, the transceiver(s) 424 can utilize multiple-input/multiple-output (MIMO) technology. The transceiver(s) 424 can be any sort of wireless transceivers capable of engaging in wireless, radio frequency (RF) communication. The transceiver(s) 424 can also include other wireless modems, such as, but not limited to, a modem for engaging in Wi-Fi, WiMax, Bluetooth, or infrared communication.

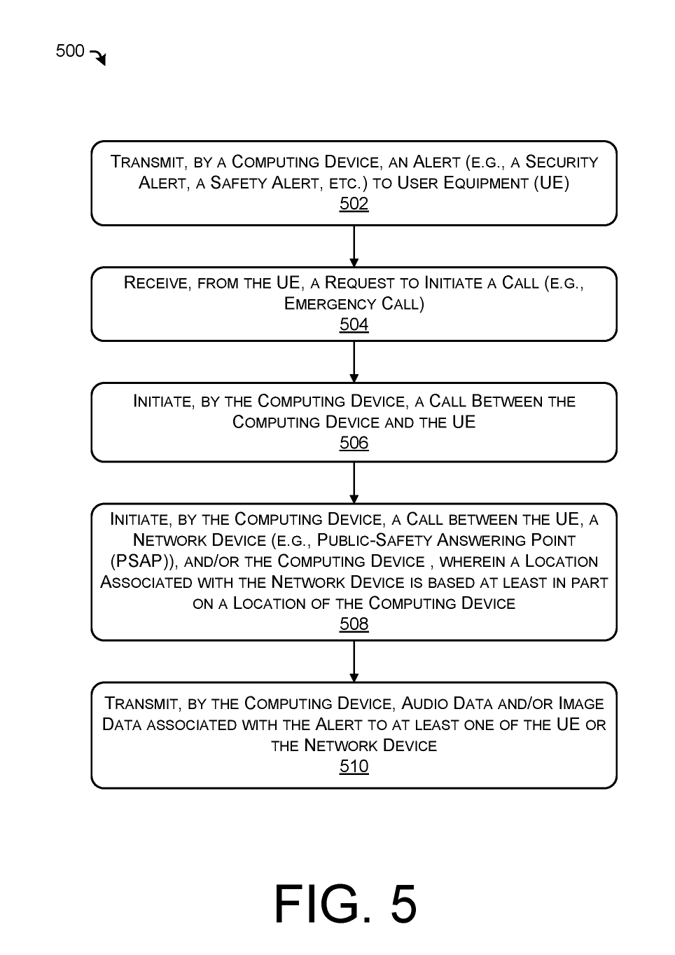

FIGS. 5-7 illustrate example processes in accordance with embodiments of the disclosure. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

FIG. 5 illustrates an example process 500 for remotely triggering a communication through a local computing device, as described herein. The example process 500 can be performed by the computing device 102 or 104 (or another component), in connection with other components discussed herein. Some or all of the process 500 can be performed by one or more devices, equipment, or components illustrated in FIGS. 1-4, for example.

At 502, the operation can include transmitting, by a computing device, an alert (e.g., a security alert, a safety alert, etc.) to a user equipment (UE). In some instances, the computing device can be a home security device implemented in a home or office environment. In some instances, the computing device can be implemented as a personal emergency response system (PERS). As can be understood, any type of security alert or safety alert can be provided in the operation 502. In some instances, the computing device can be a first computing device, and the operation 502 can include receiving the alert at a second computing device (e.g., the computing device 104).

At 504, the operation can include receiving, from the user equipment, a request to initiate a call (e.g., an emergency call). For example, the operation 504 can include causing an indication of the alert to be presented by a user equipment, and receiving a response from the user equipment regarding confirmation of the alert. In some instances, the operation 504 can include transmitting image data, audio data, or other data (e.g., data from sensors associated with the computing device or other devices associated with the computing device) from the computing device (e.g., the source of the alert) to the user equipment to facilitate a communication and/or to provide additional information to the user equipment regarding the state of the alert. In some instances, the request to initiate a call can include any call, and is not limited to emergency calls.

At 506, the operation can include initiating, by the computing device, a call between the computing device and the user equipment. In some instances, the operation 506 can include the computing device initiating a communication session via a cellular wireless connection.

At 508, the operation can include initiating, by the computing device, a call between the UE, the network device (e.g., a public-safety answering point (PSAP)), and/or the computing device, wherein a location associated with the network device is based at least in part on a location of the computing device. In some instances, the operation 508 can include initiating an emergency call between the computing device and the network device in accordance with e911 (enhanced 911) procedures. In some instances, the operation 508 can include initiating an emergency call between the user equipment (e.g., the user equipment 106) and the network device (e.g., the network device 108) as if the user equipment 106 had initiated the call with e911 procedures from the location associated with the computing device 102. In some instances, the operation 508 can include determining a location of the computing device, and determining a relevant network device (e.g., servicing a location corresponding to the location of the computing device).

In some instances, the call in the operation 506 can be a first call, and the call in the operation 508 can be a second call. In some instances, the first call can be initiated at a first time before a second time of initiating the second call. In some instances, the first call can be initiated at a second time after a first time of initiating the second call. In some instances, the first call and the second call can be initiated substantially simultaneously. In some instances, the first call or the second call can be initiated, and the subsequently-initiated call can be joined to the earlier-initiated call to form a conference call. Of course, the disclosure contemplates a plurality of operations and ordering of operations, as discussed herein.

As discussed herein, in some instances, the first call (corresponding to the call in the operation 506) can be between a first device (e.g., 102 or 202) and a second device (e.g., 106 or 204), while the second call (corresponding to the call in the operation 508) can be between the second device (e.g., 106 or 204) and a third device (e.g., 104 or 106), or between the first device, the second device, and the third device. Of course, any number and/or combinations of devices involved in communications are contemplated herein.

In some instances, the network device can be any device, and is not limited to a PSAP. For example, the network device can include any device that is configured to send and/or receive wired or wireless data. In some instances, the network device can be selected from a user profile stored in advance of determining an alert, for example. In some instances, a network device can be selected based at least in part on a type/severity of an alert. For example, for a water leak alert, the network device can include a plumber. For a fire alert, the network device can include an e911 destination (or an emergency responder based on a country or jurisdiction). Additional network devices are contemplated herein.

At 510, the operation can include transmitting, by the computing device (e.g., the computing device 102 or 104), audio data, image data, and/or other data associated with the alert to at least one of the user equipment or the network device. For example, the computing device can continue to capture audio data and/or image data of an environment, and can provide such audio data and/or image data to the user equipment and/or the network device. In some instances, the operation 510 can include transmitting audio data and/or image data to and/or from the user equipment and/or the network device. In some instances, the computing device may not be involved in the call established in the operation 510, and thus, the operation 510 may not be performed in all cases.

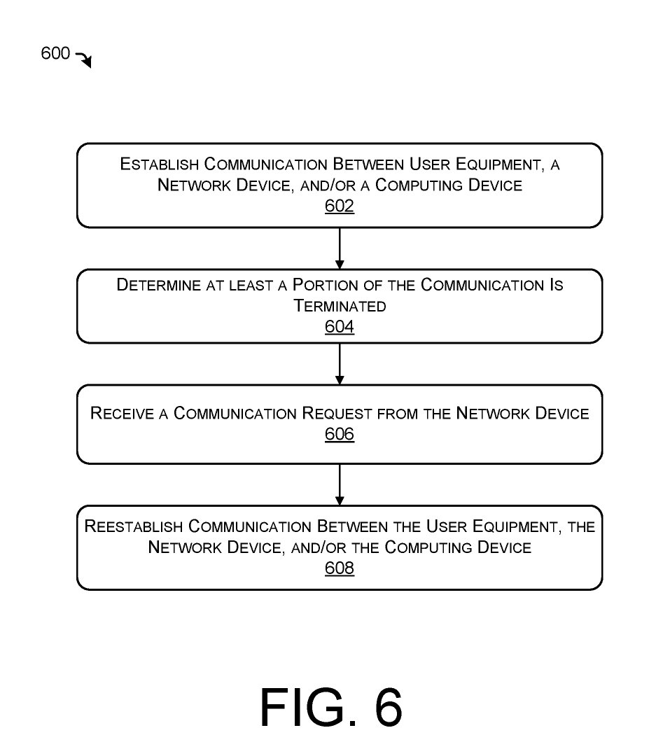

FIG. 6 illustrates an example process 600 for reestablishing a communication, as described herein. The example process 600 can be performed by the computing devices 102, 104, 106, 202, or 204 (or another component), in connection with other components discussed herein. Some or all of the process 600 can be performed by one or more devices, equipment, or components illustrated in FIGS. 1-4, for example.

At 602, the operation can include establishing a communication between a user equipment, a network device, and/or a computing device. In some instances, the communication can be established in accordance with the operations discussed in connection with the process 500. In some examples, the computing device can correspond to the computing devices 102, 104, or 202. In some examples, the user equipment can correspond to a user equipment 106 or 204. In some instances, the network device can correspond to the network device 108.

At 604, the operation can include determining at least a portion of communication is terminated. In some instances, the operation can include monitoring signaling associated with the communication to determine if the communication was terminated (e.g., ended) in accordance with signaling procedures (e.g., Session Initiation Protocol (SIP)). In some instances, the operation 604 can determine that a communication as terminated abruptly, or that the communication was otherwise disrupted. In some instances, for example, involving a conference call involving a plurality of devices, the operation 604 can include identifying a particular device for which the communication was terminated.

At 606, the operation can include receiving a communication request from the network device. In some instances, the network device (e.g., a PSAP) may attempt to reestablish communication with the computing device and/or the user equipment upon the communication being interrupted. In such a case, the network device may attempt to establish the communication with the computing device, as the network device may not necessarily know addressing information associated with the user equipment (e.g., a native number associated with the user equipment). In some instances, the operation 606 can include receiving the communication request from the network device and determining a native number and/or communication identifier associated with the user equipment.

At 608, the operation can include reestablishing a communication between the user equipment, the network device, and/or the computing device. In some instances, the operation 608 can include accepting, by the computing device or user equipment, the communication request from the network device. In some instances, the operation 608 can include transmitting a second communication request to the user equipment utilizing the native number and/or communication identifier associated with the user equipment (e.g., with or without attempting to establish a communication at the computing device). In some instances, the operation 608 can include establishing a conference call between the computing device, the user equipment, and the network device, and in some instances, the operation 608 can include joining the two-party communication between the computing device and the network device and the computing device and the user equipment to form a conference call. In some instances, the computing device may not be contacted in response to determining that at least a portion of the communication has been terminated.

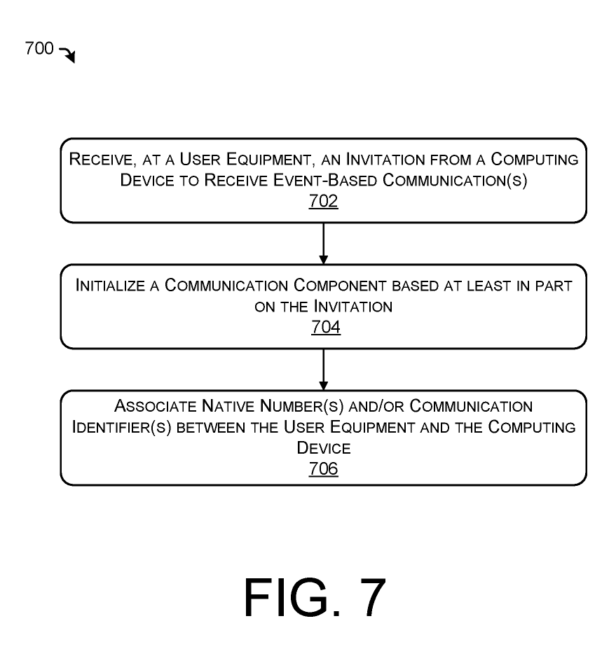

FIG. 7 illustrates an example process for receiving an invitation to receive a communication and associating a communication identifier based on accepting the invitation, as described herein. The example process 700 can be performed by the user equipment 106 or 204 (or another component), in connection with other components discussed herein. Some or all of the process 700 can be performed by one or more devices, equipment, or components illustrated in FIGS. 1-4, for example.

At 702, the operation can include receiving, at a user equipment, an invitation from a computing device to receive event-based communication(s). In some instances, the user equipment can correspond to the user equipment 106 or 204. In some instances, the computing device can correspond to the computing device 102 or 202. In some instances, the invitation can be transmitted based at least in part as part of a registration process or as part of setting up devices to contact in connection with an event or emergency. In some instances, the event-based communication can correspond to a security alert (e.g., an alarm generated by a home security system) or a safety alert (e.g., generated by a safety condition in connection with a personal emergency response system (PERS)). Of course, other event-based communications are contemplated herein, and are not limited to security or safety alerts.

At 704, the operation can include initializing a communication component based at least in part on the invitation. In some instances, the operation 704 can include downloading or installing an application onto the user equipment to receive the event-based communication(s), as discussed herein. In some instances, the communication component can be preinstalled on the user equipment, and the operation 704 can include associating the user equipment with the computing device.

At 706, the operation can include associating one or more native number(s) and/or one or more communication identifier(s) between the user equipment and the computing device. In some instances, a communication identifier can be associated with the user equipment and the computing device such that when the computing device initiates a communication with a network device utilizing the communication identifier, as discussed herein, and when a communication is reestablished by the network device, the communication request initiated by the network device is received by the computing device and the user equipment, based at least in part on the communication identifier. In some instances, a communication identifier may not be activated until an actual alert is triggered by the computing device. Thus, in some instances, the communication identifier is activated at the user equipment and/or at the computing device based at least in part on a determination of an event or alert, as discussed herein. Thus, the operations discussed herein provide additional security and connectivity when implementing a security device or a PERS.

Of course, it may be understood in the context of this disclosure that the operations in FIG. 7 can be performed during activation of a security device or PERS, at any time, or can be omitted entirely. For example, a user of a security device or PERS can unilaterally set a native number or a communication identifier to receive an alert, without sending an invitation to the device associated with the native number or communication identifier.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A system comprising:
one or more processors;
a memory; and
one or more components stored in the memory and executable by the one or more processors to perform operations comprising:
transmitting an alert associated with a computing device to a user equipment, the alert indicative of a security event associated with an environment in which the computing device is installed;
receiving, from the user equipment, a request to initiate a first communication based at least in part on the alert;
initiating the first communication between the computing device and the user equipment;
initiating a second communication between the computing device and a network device associated with a public-safety answering point, wherein a first location associated with the network device is based at least in part on a second location of the computing device; and
transmitting data associated with the alert to at least one of the user equipment or the network device.

2. The system of claim 1, wherein the audio data is first audio data, wherein the image data is first image data, and wherein the operations further comprise:
transmitting, by the computing device, at least one of second audio data or second image data to the user equipment prior to initiating the first communication between the computing device and the user equipment.

3. The system of claim 1, wherein the operations further comprise:
transmitting an invitation to the user equipment to receive one or more alerts from the computing device;
receiving, from the user equipment, an indication of an acceptance of the invitation; and
associating, based at least in part on the indication, a communication identifier between the user equipment and the computing device.

4. The system of claim 3, wherein the operations further comprise:
determining that the second communication has ended;
receiving, from the network device, a request to initiate a third communication between the network device and the computing device; and
initiating, based at least in part on the request and based at least in part on the communication identifier, the third communication between the network device, the computing device, and the user equipment.

5. The system of claim 1, wherein the first communication and the second communication collectively form a conference call between the computing device, the user equipment, and the network device.

6. A system comprising:
one or more processors;
a memory; and
one or more components stored in the memory and executable by the one or more processors to perform operations comprising:
transmitting data associated with a computing device to a user equipment;
receiving, from the user equipment, an indication based at least in part on the data; and
initiating a communication between at least the user equipment and a network device, wherein a first location associated with the network device is based at least in part on a second location of the computing device.

7. The system of claim 6, wherein the computing device is a personal emergency response system (PERS).

8. The system of claim 6, wherein the computing device is a home security device.

9. The system of claim 6, wherein the indication includes a request to initiate the communication based at least in part on the data.

10. The system of claim 6, wherein the operations further comprise:
associating a communication identifier between the user equipment and the computing device.

11. The system of claim 10, wherein the communication is a first communication, and wherein the operations further comprise:
determining that the first communication has ended;
receiving, from the network device, a request to initiate a second communication between the network device and at least one of a native number or the communication identifier associated with the computing device; and
initiating, based at least in part on the request, the second communication between at least the network device and the user equipment.

12. The system of claim 6, wherein operations further comprise:
transmitting the indication to the computing device, wherein the communication is a cellular communication initiated by the computing device further based at least in part on the indication.

13. The system of claim 6, wherein the operations further comprise:
receiving location information associated with the computing device; and
determining the second location based at least in part on the location information.

14. The system of claim 6, wherein the operations further comprise:
receiving identity information associated with the computing device;
determining that the user equipment is associated with the computing device based at least in part on the identity information; and
transmitting the data to the user equipment based at least in part on determining that the user equipment is associated with the computing device.

15. A processor-implemented method comprising:
transmitting an alert associated with a computing device to a user equipment;
receiving, from the user equipment, an indication based at least in part on the alert; and
initiating a communication between the user equipment and a network device, wherein a first location associated with the network device is based at least in part on a second location of the computing device.

16. The processor-implemented method of claim 15, wherein the processor-implemented method further comprises:
receiving the alert from the computing device, wherein the indication includes a request to initiate the communication based at least in part on the alert.

17. The processor-implemented method of claim 15, wherein the indication is a first indication, and wherein the processor-implemented method further comprises:
transmitting an invitation to the user equipment to receive one or more alerts from the computing device;
receiving, from the user equipment, a second indication of an acceptance of the invitation; and
associating, based at least in part on the second indication, a communication identifier between the user equipment and the computing device.

18. The processor-implemented method of claim 17, wherein the communication is a first communication, and wherein the processor-implemented method further comprises:
determining that the first communication has ended;
receiving, from the network device, a request to initiate a second communication; and
initiating, based at least in part on the request, the second communication between the network device and the user equipment.

19. The processor-implemented method of claim 15, wherein the processor-implemented method further comprises:
transmitting the indication to the computing device, wherein the communication is a cellular communication initiated by the computing device further based at least in part on the indication.

20. The processor-implemented method of claim 15, wherein the processor-implemented method further comprises:
receiving identity information associated with the computing device;
determining that the user equipment is associated with the computing device based at least in part on the identity information; and
transmitting the alert to the user equipment based at least in part on determining that the user equipment is associated with the computing device.
